(19) United States
(12) Patent Application Publication
(10) Pub. No.: US 2011/0146121 A1
(43) Pub. Date: Jun. 23, 2011

(54) ROTATING BILLBOARD

(76) Inventor: Glenn Gerrard R. Gatuslao, Makati (PH)

(21) Appl. No.: 12/997,861

(22) PCT Filed: Sep. 11, 2009
(86) PCT No.: PCT/PH2009/000013

§ 371 Date: Dec. 13, 2010

(30) Foreign Application Priority Data
Sep. 11, 2008 (PH) 2-2008-000407

(51) Int. Cl. G09F 15/00; G09F 19/02; F16M 11/22; B23P 17/04

(52) U.S. Cl. 40/606.01; 248/188.8; 248/156; 29/428

(57) ABSTRACT

The Rotating Billboard is an improvement of the structures which are now being used by outdoor billboard operators in the industry. The current standard of the contemporary billboard structure consists of a steel frame on which a high resolution advertising material is tied using steel wires and illuminated using front-lit metal halides using steel light supports. The weight of the frame is supported by a series of web-like large steel angle bars and thrushes engineered to fully secure the structure in case of adverse weather conditions. The base is bolted through a concrete slab which is buried deeply beneath the ground. The Rotating Billboard is a smaller structure and may be strategically located on areas where the contemporary billboard could not. The frame of the Rotating Billboard is composed of four sides and is illuminated from the inside. Thus, having a more modern, clean and aesthetically gallant image as compared to traditional billboards where the lightings are exposed and the steel light support braces provide a hazardous feel when people pass under it. The steel frame is supported by a movable steel cylinder inserted through a larger non-moving cylinder the base of which is bolted by a series of knots to a concrete slab that is buried on the ground. The ball bearing assembly on which the inner cylinder rests allows clockwise and counter-clockwise rotation rendering directional flexibility on the advertising media faces. The initial utility model may be maneuvered manually, although future enhancements may feature automation for added attractiveness.

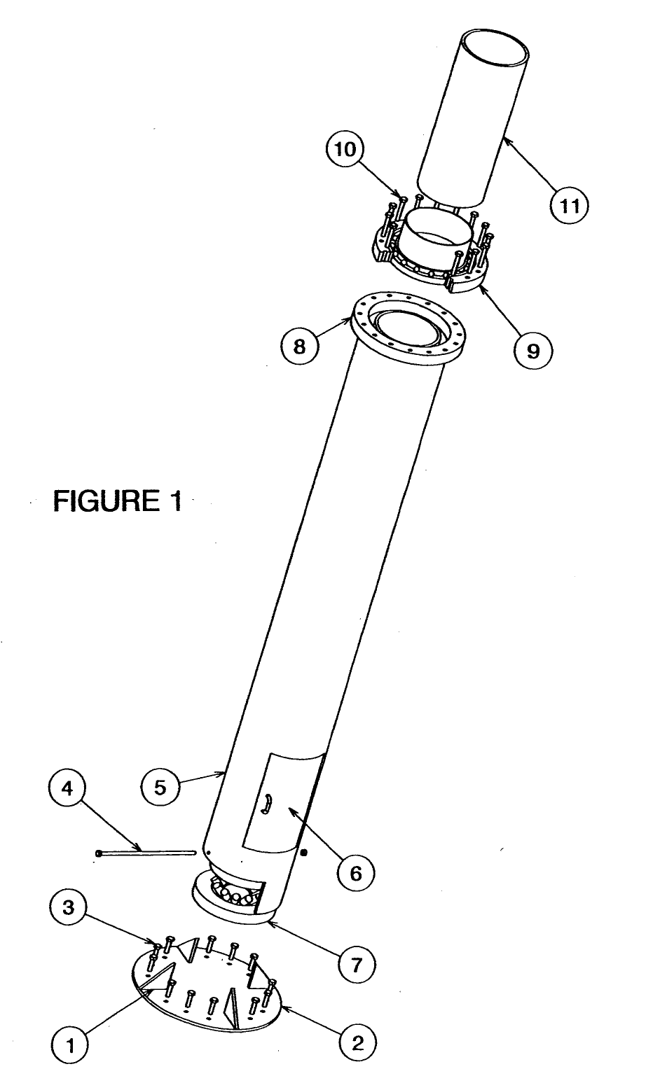

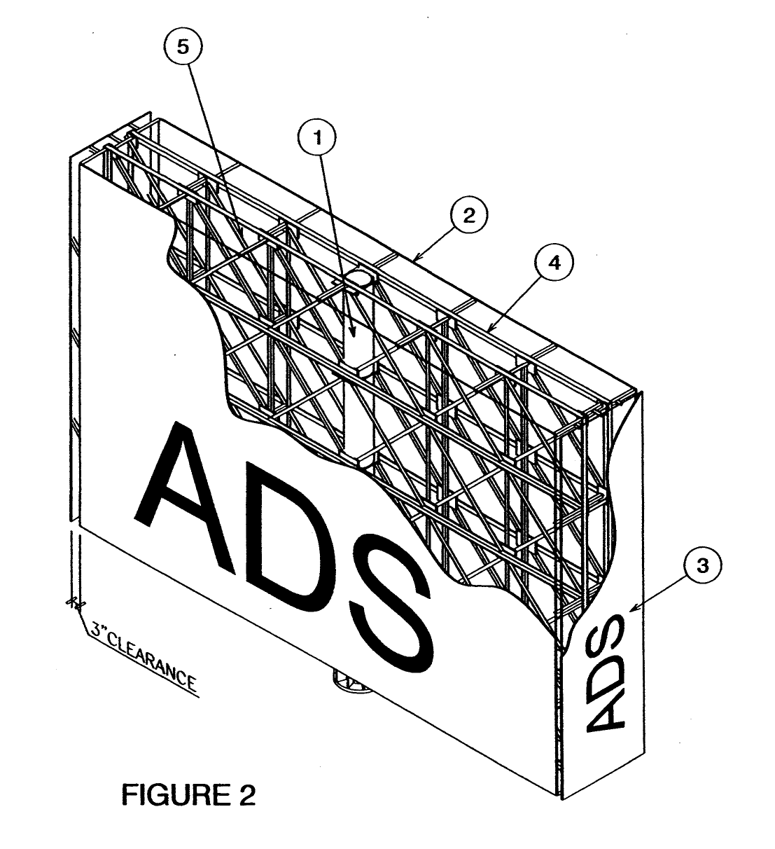

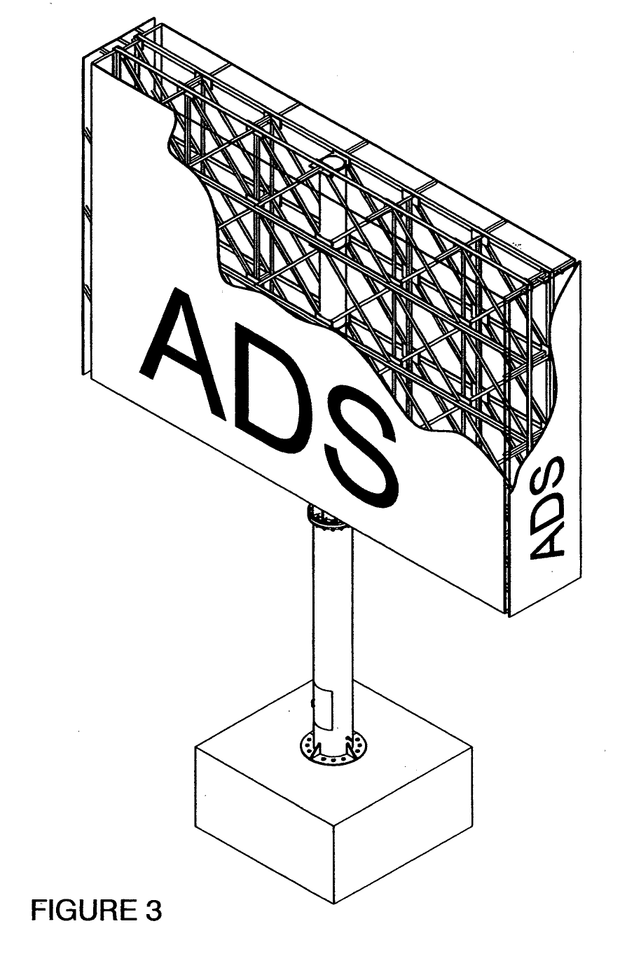

### BRIEF STATEMENT OF ITS NATURE AND PURPOSE

The Rotating Billboard structure consumes lesser space compared to the contemporary ones which would require at least 100 square meters of lot area for a 40×60 steel frame to be mounted. The rotating feature enables advertisers to display their ad material at different angles visible from all directions preferred at a given time. This revolutionary billboard model is calculated to attract more advertisers as it offers a unique and wider scope in terms of capturing the attention of prospective clients.

### BRIEF EXPLANATION OF THE DRAWING

Front Elevation

The maiden utility model will stand 10.5 meters with frame measuring 9 meters wide and 6 meters in height.

Side Elevation

The frame is 1.2 meter thick as illustrated on the top view. For detail A, the assembly has 0.45 M steel pipe and 3×3×¼ angle bar and 2×2×¼ angle bar for the billboard frame. Meanwhile, Detail B consists of 3×3×¼ angle bar and 2×2×¼ angle with 0.6 M steel pipe.

The Column—Footing Detail

The footing is made of 16-16 MM vertical bars with 10 mm stirrups and 16 mm deformed bar top and bottom both ways.

Detail of Anchor Bolt

The footing detail consists of 0.6 meter steel pipe with base plate 25 millimeter thick and anchor bolt at 20 millimeter in dimension.

Side Pipe Connection

There will be bearing assembly inside both ends of the larger cylinder. Steel rod with washer will serve as lock to keep the rotating cylinder from moving or rotating by itself caused by gusty winds or typhoon.

Ball Bearing

Ball bearing connected in a flange will be the mechanism in the upper end of the larger pipe. It also supports radial and axial loads.

Thrust Bearing

Connected in the lower portion and in the smaller pipe, thrust bearing is used for supporting higher axial load.

Service Area

A 400×750 mm door will be provided in the larger pipe for easy maintenance of mechanisms located inside.

Illumination

Backlit illumination using preferably Led or Fluorescent lamps but not limited to using neon or metal halides. Power used for illumination is preferably NC, DC or Solar Power. But not limited to other power sources like wind, coal & hydro as the case may be.

Frames

The frame itself has a unique feature using four sides as compared to traditional or conventional static billboards which only utilizes two sides. The frame is designed to accommodate for backlit illumination using panaflex, acrylic, and tarpaulin. But may be installed with neon illumination and be mounted an electrical TV board.

Complete and Detailed Enabling Description

The Rotating Billboard is a 9-meter tall steel structure with a frame measuring 6 meters×9 meters supported by 4.5 meter steel cylinder with 0.60 meter in diameter and 0.12 mm in thickness. The height is proportionate to its body and base to maintain its sturdiness from top to bottom, however larger frame sizes of 14×18 meters may also be accommodated. This can withstand typhoon and gusty winds even with the tarpaulin on since it may be rotated through the pressure and strength of the wind. The lighting facility consists of a series of 40 watts fluorescent lamps numbering 128 units placed inside the steel frame box providing bright illumination evenly diffused on both faces of the tarpaulin ad material.

The billboard may be rotated by diffusing the built-in ladder attached to the larger steel cylinder to access and to manually rotate the movable cylinder. The personnel will have to use safety belt for added protection while manually rotating the billboard. The built-in ladder may also be used in changing tarpaulin ad material.

The efficiency of bearing function and the accuracy in the calculation to determine the fulcrum point (center where weight is balanced from all sides) of the moving cylinder should lessen the friction that will allow ease in rotation. Ideally, one person may easily rotate the moving part of the structure. A safety lock is then provided to ensure unnecessary movement in the event of typhoon or gusty winds.

Rotating Billboard Pole

Referring now to the several views of the drawings, wherein like reference numerals designate same parts throughout, shown is the exploded view for Rotating Billboard Pole. The Rotating Billboard Pole comprises of vertical cylindrical pipes 5 and 11, ball bearing 9 and thrust bearing 7.

Said vertical cylindrical pipes preferably made of steel, is composed of an inner pipe 11 that is movable mounted to a larger pipe 5 that is non-moving with base plate 2 bolted by a series of knots 3 to a concrete slab buried on the ground. The said ball bearing assembly 9 is disposed at the end of the external portion of the upper cylinder allowing ease in the rotation and maintaining alignment for the internal pipe. The said bearing has the purpose of greatly reducing rotational friction and supporting axial and radial loads. It is also the least expensive because of the low cost in the production of the balls. Said thrust bearing assembly 7 is engaged with the internal pipe for free wheeling and carrying the heavy load. Thrust bearing is designed to achieve high thrust capacity with low friction and continuous roller alignment. An attribute of internal self-alignment of the bearing elements during operation compensates for shaft deflections caused by shock or heavy loads. Thrust bearing of any kind that will meet the design requirements and specifications shall be used. Other option for the bottom of the inside cylindrical pipe is the use of a ball bearing instead of a thrust bearing elevated at a certain distance. A flange inside will connect and hold the bearing. A small pipe is being guided by the ball bearing that is connected to the inside cylindrical pipe for smooth rotation and alignment.

The Rotating Billboard can be manually rotated via a rope and a hook, or a worm gear. The hook will be attached to one end of the frame and a rope will be tied for a person to hold and to manually rotate it. The worm gear can also be used as an alternative for a rope because it has the ability of reducing great speed in the rotation of the frame.

The foregoing description is provided for illustrative purposes only and should not be construed as in any way limiting this utility model of having future technical modifications, the scope of which is defined solely by the appended claims.

Rotating Billboard Frame

Referring now to the several views of the drawings, wherein like reference numerals designate same parts throughout, shown is the isometric view for Rotating Billboard Frame. The Rotating Billboard Frame comprises of manual rotating billboard pole 1, angle bars 4 and 5, round bar 2 and backlit panaflex, acrylic, and/or tarpaulin 3.

Said rotating billboard pole 1 is a cylindrical steel pipe that is movable and mounted vertically through a larger pipe. Said angle bars are 3″×3″×½″ 4 and 2″×2″×¼″ 5 designed to comprise mostly of the frame structure that can withstand typhoon and gusty winds. The said round bar 2 has a diameter of 10 mm that will support and hold the backlit panaflex, acrylic, and/or tarpaulin. Angle bar will be welded to the round bar with a clearance of 3 inches (approximately 80 mm) from the rectangular frame. Backlit panaflex, acrylic, and/or tarpaulin 3 are the materials to be used for better illumination.

The foregoing description is provided for illustrative purposes only arid should not be construed as in any way limiting this utility model, the scope of which is defined solely by the appended claims.

Methodology

Two types of mechanical bearing will be installed in the Rotating Billboard to allow a relative motion between parts for rotational movement. For the vertically mounted rotating poles, considering the radial and axial load, a ball bearing will be used in the upper portion of the pole and a thrust bearing in the lower portion.

Ball bearings can support both radial (perpendicular to the shaft) and axial loads (parallel to the shaft). It will be very useful in the operation for maintaining the alignment of the shaft. As a guide and rotating mechanism for the pole, ball bearings help maintain a good alignment for the thrust bearing in the lower portion. Also, of all the bearings available, ball bearing is the least expensive because of the low cost in producing the balls.

Thrust bearing is a particular type of rotary bearing which are designed to support heavy axial load permitting the rotation between parts. A spherical roller type of thrust bearing will be used to achieve high thrust capacity with low friction and continuous roller alignment. An attribute of internal self-alignment of the bearing elements during operation compensates for shaft deflections caused by shock and or heavy loads. Also, the ball bearing installed will be of great use for the thrust bearing to rotate properly and carry the high axial load.

1. An apparatus comprising:
an outside cylindrical pipe;
an inside cylindrical pipe configured to rotate, the inside cylindrical pipe mounted within the outside cylindrical pipe;
a first bearing;
a second bearing; and
a frame supported by the inside cylindrical pipe.

2. The apparatus of claim 1, wherein the apparatus is used in an outdoor environment.

3. The apparatus of claim 1, wherein the frame has interior illumination.

4. The apparatus of claim 1, further comprising:
a lock to keep the inside cylindrical pipe from rotating.

5. The apparatus of claim 1, further comprising:
a base mounted to a concrete slab buried on the ground.

6. The apparatus of claim 1, wherein the first bearing is a ball bearing.

7. The apparatus of claim 6, wherein the second bearing is a ball bearing or a thrust bearing.

8. The apparatus of claim 1, wherein the inside cylindrical pipe and the outside cylindrical pipe are mounted together to form a structure 10.5 m in length.

9. A method comprising:
mounting an inner pipe within an outer pipe;
engaging the inner pipe with a first assembly configured to allow the inner pipe to rotate and to maintain alignment for the inner pipe;
engaging the inner pipe with a second assembly configured to allow the inner pipe to rotate and to support axial load of the inner pipe; and
supporting a frame by the inner pipe.

10. The method of claim 9, further comprising:
using the supported frame in an outdoor environment.

11. The method of claim 9, further comprising:
illuminating from within the frame.

12. The method of claim 9, further comprising:
keeping the inner pipe from rotating.

13. The method of claim 9, further comprising:
mounting a base to a concrete slab buried on the ground.

14. The method of claim 9, wherein the first assembly is a ball bearing and the second assembly is a bearing.

15. The method of claim 14, wherein the second assembly is a ball bearing or a thrust bearing.

16. The method of claim 9, wherein the inner pipe and the outer pipe are mounted together to form a structure 10.5 m in length.

17. An apparatus comprising:
means for displaying advertising material;
means for supporting the displaying means; and
means for allowing rotation of the supporting means.
